(19) United States
(12) Patent Application Publication
(10) Pub. No.: US 2018/0173623 A1
(43) Pub. Date: Jun. 21, 2018

(54) REDUCING OR AVOIDING BUFFERING OF EVICTED CACHE DATA FROM AN UNCOMPRESSED CACHE MEMORY IN A COMPRESSED MEMORY SYSTEM TO AVOID STALLING WRITE OPERATIONS

(71) Applicant: QUALCOMM Incorporated, San Diego, CA (US)

(72) Inventors: Christopher Edward Koob, Round Rock, TX (US); Richard Senior, San Diego, CA (US); Gurvinder Singh Chhabra, San Diego, CA (US); Andres Alejandro Oportus Valenzuela, San Diego, CA (US); Nieyan Geng, San Diego, CA (US); Raghuveer Raghavendra, San Diego, CA (US); Christopher Porter, San Diego, CA (US); Anand Janakiraman, San Diego, CA (US)

(21) Appl. No.: 15/385,991

(22) Filed: Dec. 21, 2016

(51) Int. Cl. G06F 12/0804; G06F 12/12

(52) U.S. Cl. CPC G06F 12/0804; G06F 12/12; G06F 2212/69; G06F 2212/1044; G06F 2212/401; G06F 2212/1016

(57) ABSTRACT

Aspects disclosed involve reducing or avoiding buffering evicted cache data from an uncompressed cache memory in a compressed memory system to avoid stalling write operations. Metadata is included in cache entries in the uncompressed cache memory, which is used for mapping cache entries to physical addresses in the compressed memory system. When a cache entry is evicted, the compressed memory system uses the metadata associated with the evicted cache data to determine the physical address in the compressed system memory for storing the evicted cache data. In this manner, the compressed memory system does not have to incur the latency associated with reading the metadata for the evicted cache entry from another memory structure that may otherwise require buffering the evicted cache data until the metadata becomes available, to write the evicted cache data to the compressed system memory to avoid stalling write operations.

### BACKGROUND

### I. Field of the Disclosure

The technology of the disclosure relates generally to computer memory systems, and more particularly to compression memory systems configured to compress and decompress data stored in and read from compressed system memory.

### II. Background

As applications executed by conventional processor-based systems increase in size and complexity, memory capacity requirements may increase. Memory size can be increased in a processor-based system to increase memory capacity. However, increasing the memory size may require increasing the area for providing additional memory. For example, providing additional memory and/or wider memory addressing paths to increase memory size may incur a penalty in terms of increased cost and/or additional area for memory on an integrated circuit (IC). Further, increasing memory capacity can increase power consumption and/or impact overall system performance of a processor-based system. Thus, one approach to increase memory capacity of a processor-based system without having to increase memory size is through the use of data compression. A data compression system can be employed in a processor-based system to store data in a compressed format, thus increasing effective memory capacity without increasing physical memory capacity.

In some conventional data compression systems, a compression engine is provided to compress data to be written to a main system memory. After performing data compression, the compression engine writes the compressed data to the system memory. Because the effective memory capacity is larger than the actual memory size, a virtual-to-physical address translation is performed to write compressed data to system memory. In this regard, some conventional data compression systems additionally write compressed data along with “metadata” to system memory. The metadata is data that contains a mapping of the virtual address of the compressed data to the physical address in the system memory where the compressed data is actually stored. However, the use of metadata may result in an increased risk of stalling the processor when cache data is evicted from a cache memory to be stored in system memory. For example, in data compression schemes in which different sized blocks are tracked for use in storing compressed data, a write operation to the system memory (e.g., resulting from an eviction from a cache memory) may require a lookup to the system memory to determine whether a previously used block for storing compressed data can be reused. Due to inherent memory latency, accessing metadata in this manner may result in a processor stall while the metadata is retrieved.

It is desired to provide a more efficient mechanism for accessing metadata for compressed data to avoid processor stalls when evicting data from system caches, while minimizing system memory used for buffering.

### SUMMARY OF THE DISCLOSURE

Aspects of the present disclosure involve reducing or avoiding buffering of evicted cache data from an uncompressed cache memory in a compressed memory system to avoid stalling write operations. In exemplary aspects disclosed herein, metadata is included in cache entries in the uncompressed cache memory, which is used for mapping the cache entries to physical addresses in the compressed memory system. When a cache entry is evicted from the cache memory, the cache memory can pass the metadata for the evicted cache entry along with the cache data from the evicted cache entry to the compressed memory system. The compressed memory system is configured to use the metadata received from the cache memory associated with the evicted cache data to access the physical address in the compressed system memory to store the evicted cache data. The compressed memory system compresses the evicted cache data, if possible, to be stored in a compressed system memory. In this manner, the compressed memory system does not have to incur the latency associated with reading the metadata for the evicted cache entry from another memory structure, such as a metadata cache or from the compressed system memory. This latency could require the compressed memory system to provide a memory structure to buffer the evicted cache data until the metadata becomes available to write the evicted cache data at the mapped physical address compressed system memory, to otherwise avoid stalling write operations in the processor.

In this regard, in one exemplary aspect, a memory system is provided. The memory system comprises a compression circuit configured to store compressed data in a memory block in a memory entry among a plurality of memory entries in a compressed system memory. Each memory entry among the plurality of memory entries is addressable by a physical address. The memory system also comprises a cache memory communicatively coupled to the compression circuit. The cache memory comprises a plurality of cache entries each configured to store uncompressed cache data and an associated metadata associated with a physical address identifying a memory entry in the compressed system memory containing compressed cache data. In response to an eviction of a cache entry from the cache memory, the cache memory is configured to provide uncompressed cache data and the associated metadata from the cache entry to be evicted among the plurality of cache entries to the compression circuit. Also, in response to the eviction of the cache entry from the cache memory, the compression circuit configured to receive the uncompressed cache data and the associated metadata from the cache entry to be evicted among the plurality of cache entries in the cache memory, compress the uncompressed cache data into compressed data of a compression size, and store the compressed data in a memory block in a memory entry at a physical address in the compressed system memory associated with the received associated metadata with the evicted cache entry.

In another exemplary aspect, a method of evicting cache data from an evicted cache entry to a compressed system memory is provided. The method comprises receiving uncompressed cache data and associated metadata from a cache entry to be evicted among a plurality of cache entries in a cache memory. The method also comprises compressing the uncompressed cache data into compressed data of a compression size. The method also comprises storing the compressed data in a memory block in a memory entry at a physical address in a compressed system memory, the physical address associated with the received associated metadata with the evicted cache entry.

In another exemplary aspect, a processor-based system is provided. The processor-based system comprises a processor core configured to issue memory read operations and memory write operations. The processor-based system also comprises a compressed system memory comprising a plurality of memory entries each addressable by a physical address and each configured to store compressed data. The processor-based system also comprises a cache memory communicatively coupled to the processor core. The cache memory comprises a plurality of cache entries each configured to store uncompressed cache data and an associated metadata associated with a physical address identifying a memory entry in the compressed system memory containing compressed cache data. The processor-based system also comprises a compression circuit configured to store compressed data in a memory block in a memory entry among the plurality of memory entries in the compressed system memory. In response to an eviction of a cache entry from the cache memory, the cache memory is configured to provide the uncompressed cache data and the associated metadata from the cache entry to be evicted among the plurality of cache entries to the compression circuit. Also, in response to the eviction of the cache entry from the cache memory, the compression circuit is configured to receive the uncompressed cache data and the associated metadata from the cache entry to be evicted among the plurality of cache entries in the cache memory, compress the uncompressed cache data into compressed data of a compression size, and store the compressed data in a memory block in a memory entry at a physical address in the compressed system memory associated with the received associated metadata with the evicted cache entry.

### BRIEF DESCRIPTION OF THE FIGURES

FIG. 1 is a schematic diagram of an exemplary processor-based system that includes a compression memory system configured to compress cache data from an evicted cache entry in a cache memory, and read metadata used to access the physical address in a compressed system memory to write the compressed evicted cache data;

FIG. 2 is a flow diagram illustrating an exemplary process of the processor-based system in FIG. 1 evicting a cache entry from a cache memory, compressing the cache data from the evicted cache entry, and writing the compressed cache data at a physical address in the compressed system memory determined from read metadata mapping to the virtual address of the evicted cache entry to its physical address in the compressed system memory;

FIG. 3 is a schematic diagram of an exemplary processor-based system that includes a memory system comprising a cache memory configured to store uncompressed cache data and associated metadata used to access the physical address of the cache data in compressed system memory, and a compression circuit configured to compress the evicted cache data and write the compressed evicted cache data at a physical address determined by the received metadata, to avoid the need to read the metadata thus potentially stalling the processor during subsequent write operations;

FIG. 4 is a flow diagram illustrating an exemplary cache eviction process performed in the processor-based system in FIG. 3, that includes writing compressed cache data at a physical address in the compressed system memory determined from the metadata received along with evicted cache data from an evicted cache entry, to avoid stalling the processor during subsequent write operations;

FIG. 5 is a flow diagram illustrating an exemplary memory read operation in the processor-based system in FIG. 3 in response to a cache miss to the cache memory, wherein the read data and the metadata associated with the virtual address of the memory read operation are updated in a cache entry in the cache memory;

FIG. 6 is a flow diagram illustrating an exemplary memory write operation in the processor-based system in FIG. 3; and

FIG. 7 is a block diagram of an exemplary processor-based system, such as the processor-based system in FIG. 3, configured to store compressed evicted cache data in compressed system memory at the physical address determined by using the received metadata stored with the evicted cache entry, to avoid the need to read the metadata thus potentially stalling the processor during subsequent write operations.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects of the present disclosure involve reducing or avoiding buffering of evicted cache data from an uncompressed cache memory in a compressed memory system to avoid stalling write operations. In exemplary aspects disclosed herein, metadata is included in cache entries in the uncompressed cache memory, which is used for mapping the cache entries to physical addresses in the compressed memory system. When a cache entry is evicted from the cache memory, the cache memory can pass the metadata for the evicted cache entry along with the cache data from the evicted cache entry to the compressed memory system. The compressed memory system is configured to use the metadata received from the cache memory associated with the evicted cache data to access the physical address in the compressed system memory to store the evicted cache data. The compressed memory system compresses the evicted cache data, if possible, to be stored in a compressed system memory. In this manner, the compressed memory system does not have to incur the latency associated with reading the metadata for the evicted cache entry from another memory structure, such as a metadata cache or from the compressed system memory. This latency could require the compressed memory system to provide a memory structure to buffer the evicted cache data until the metadata becomes available to write the evicted cache data at the mapped physical address compressed system memory, to otherwise avoid stalling write operations in the processor.

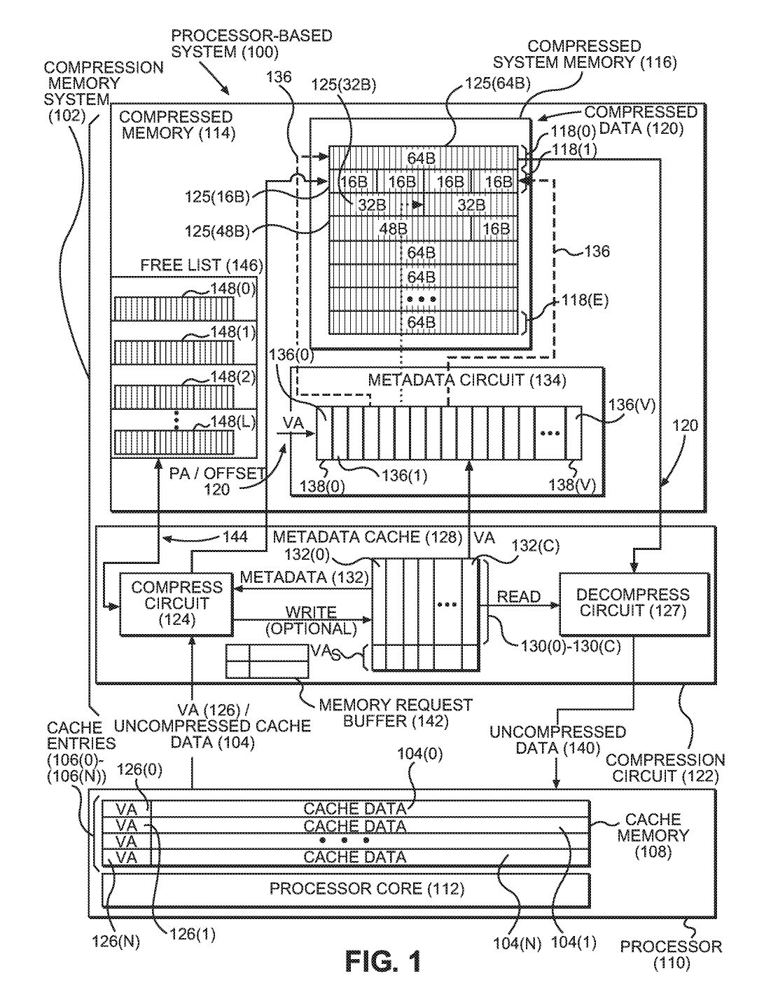

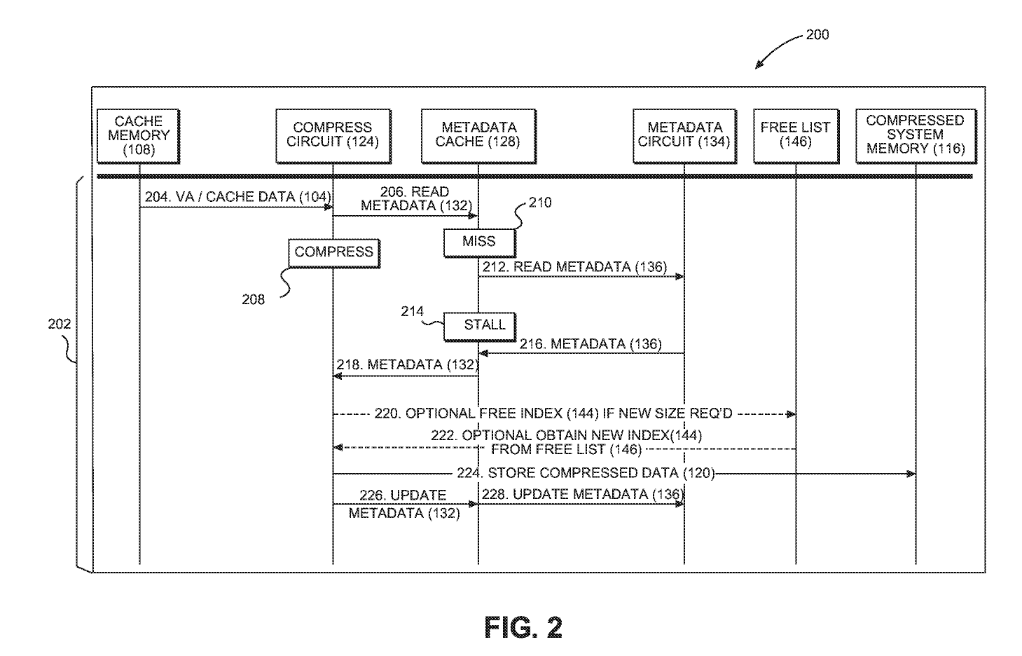

Before discussing examples of processor-based systems that include cache memories configured to store metadata in cache entries associated with uncompressed cache data for mapping the cache entries to physical addresses in a compressed system memory to avoid the need to buffer evicted cache data, FIGS. 1 and 2 are first described. FIG. 1 illustrates a processor-based system 100 that is configured to buffer evicted cache data from an evicted cache entry when stalls occur reading metadata used for determining a physical address in a compressed system memory to write the evicted cache data. FIG. 2 describes a cache eviction process performed by the processor-based system 100 in FIG. 1.

In this regard, FIG. 1 is a schematic diagram of an exemplary processor-based system 100 that includes a compression memory system 102. The processor-based system 100 is configured to store cache data 104(0)-104(N) in uncompressed form in cache entries 106(0)-106(N) in a cache memory 108. The cache entries 106(0)-106(N) may be cache lines. For example, as shown in FIG. 1, the cache memory 108 may be a level 2 (L2) cache memory included in a processor 110. The cache memory 108 may be private cache memory that is private to a processor core 112 in the processor 110 or shared cache memory shared between multiple processor cores, including the processor core 112 in the processor 110. The compression memory system 102 includes a compressed memory 114 that includes compressed system memory 116 configured to store data in a memory entry 118(0)-118(E) (which may be memory lines) in compressed form, which is shown in FIG. 1 and referred to herein as compressed data 120. For example, the compressed system memory 116 may be a double data rate (DDR) static random access memory (SRAM). The processor 110 is configured to access the compressed system memory 116 in read and write operations to execute software instructions and perform other processor operations.

Providing the ability to store the compressed data 120 in the compressed system memory 116 increases the memory capacity of the processor-based system 100 over the physical memory size of the compressed system memory 116. The processor 110 can use virtual addressing wherein a virtual-to-physical address translation is performed to effectively address the compressed data 120 in the compressed system memory 116 without being aware of the compression scheme and compression size of the compressed data 120. In this regard, a compression circuit 122 is provided in the compression memory system 102 to compress uncompressed data from the processor 110 to be written into the compressed system memory 116, and to decompress the compressed data 120 received from the compressed system memory 116 to provide such data in uncompressed form to the processor 110. The compression circuit 122 includes a compress circuit 124 configured to compress data from the processor 110 to be written into the compressed system memory 116. For example, as shown in FIG. 1, the compress circuit 124 may be configured to compress sixty-four (64) byte (64 B) data words down to forty-eight (48) byte (48 B), thirty-two (32) byte (32 B), or sixteen (16) byte (16 B) compressed data words which can be stored in respective memory blocks 125(48 B), 125(32 B), 125(16 B) of less width than the entire width of a memory entry 118(0)-118(E). If uncompressed data from the processor 110 cannot be compressed down to the next lower sized memory block 125 configured for the compression memory system 102, such uncompressed data is stored uncompressed over the entire width of a memory entry 118(0)-118(E). For example, the width of the memory entry 118(0)-118(E) may be 64 B in this example that can store 64 B memory blocks 125(64 B). The compression circuit 122 also includes a decompress circuit 127 configured to decompress the compressed data 120 from the compressed system memory 116 to be provided to the processor 110.

However, to provide for faster memory access without the need to compress and decompress, the cache memory 108 is provided. The cache entries 106(0)-106(N) in the cache memory 108 are configured to store the cache data 104(0)-104(N) in uncompressed form. Each of the cache entries 106(0)-106(N) may be the same width as each of the memory entries 118(0)-118(E) for performing efficient memory read and write operations. The cache entries 106(0)-106(N) are accessed by a respective virtual address (VA) 126(0)-126(N), because as discussed above, the compression memory system 102 provides more addressable memory space to the processor 110 than the physical address space provided in the compressed system memory 116. When the processor 110 issues a memory read request for a memory read operation, the virtual address of the memory read request is used to search the cache memory 108 to determine if the VA 126(0)-126(N), used as a tag, matches a cache entry 106(0)-106(N). If so, a cache hit occurs and the cache data 104(0)-104(N) in the hit cache entry 106(0)-106(N) is returned to the processor 110 without the need to decompress the cache data 104(0)-104(N). However, because the number of cache entries 106(0)-106(N) is ‘N+1’ which is less than the number of memory entries 118(0)-118(E) as ‘E+1’, a cache miss can occur where the cache data 104(0)-104(N) for the memory read request is not contained in the cache memory 108.

Thus, with continuing reference to FIG. 1, in response to a cache miss, the cache memory 108 is configured to provide the virtual address of the memory read request to the compression circuit 122 to retrieve the data from the compressed system memory 116. In this regard, the compress circuit 124 may first consult a metadata cache 128 that contains metadata cache entries 130(0)-130(C) each containing metadata 132(0)-132(C) indexed by a virtual address (VA). The metadata cache 128 is faster to access than the compressed system memory 116. The metadata 132(0)-132(C) is data, such as a pointer or index, used to access a physical address (PA) in the compressed system memory 116 to address to gain access to the memory entry 118(0)-118(E) containing the compressed data for the virtual address. If the metadata cache 128 contains metadata 132(0)-132(C) for the memory read operation, the compress circuit 124 uses the metadata 132(0)-132(C) to access the correct memory entry 118(0)-118(E) in the compressed system memory 116 to provide the corresponding compressed data 120 to the decompress circuit 127. If the metadata cache 128 does not contain metadata 132(0)-132(C) for the memory read request, the compress circuit 124 provides the virtual address (VA) for the memory read request to a metadata circuit 134 that contains metadata 136(0)-136(V) in corresponding metadata entries 138(0)-138(V) for all of the virtual address space in the processor-based system 100. Thus, the metadata circuit 134 can be linearly addressed by the virtual address of the memory read request. The metadata 136(0)-136(V) is used to access the correct memory entry 118(0)-118(E) in the compressed system memory 116 for the memory read request to provide the corresponding compressed data 120 to the decompress circuit 127.

With continuing reference to FIG. 1, the decompress circuit 127 receives the compressed data 120 in response to the memory read request. The decompress circuit 127 decompresses the compressed data 120 into uncompressed data 140, which can then be provided to the processor 110. The uncompressed data 140 is also stored in the cache memory 108. However, if the cache memory 108 did not have an available cache entry 106(0)-106(N), the cache memory 108 must evict an existing cache entry 106(0)-106(N) to the compressed system memory 116 to make room for storing the uncompressed data 140. In this regard, FIG. 2 is a flow diagram 200 illustrating an exemplary cache eviction process 202 performed in the processor-based system 100 in FIG. 1 when evicting a cache entry 106(0)-106(N) from the cache memory 108.

With reference to FIG. 2, the cache memory 108 first sends the VA and the uncompressed cache data 104 of the evicted cache entry 106(0)-106(N) to the compress circuit 124 as part of the cache eviction process 202 (task 204). The compress circuit 124 receives the VA and the uncompressed cache data 104 for the evicted cache entry 106(0)-106(N). The compress circuit 124 initiates a metadata read operation to the metadata cache 128 to obtain metadata 132 associated with the VA (task 206). During, before, or after the metadata read operation in task 206, the compress circuit 124 compresses the uncompressed cache data 104 into compressed data 120 to be stored in the compressed system memory 116 (task 208). If the metadata read operation to the metadata cache 128 results in a miss (task 210), the metadata cache 128 issues a metadata read operation to the metadata circuit 134 in the compressed system memory 116 to obtain the metadata 136 associated with the VA (task 212). The metadata cache 128 is stalled (task 214). Because accessing the compressed system memory 116 can take much longer than the processor 110 can issue memory access operations, uncompressed data received from the processor 110 for subsequent memory write requests will have to be buffered in a memory request buffer 142 (shown in FIG. 1), thus consuming additional area in the compression circuit 122 and power for operation. Otherwise, the processor 110 may have to be stalled in an undesired manner until the metadata 136 is obtained to be able to determine the correct physical address (PA) of the memory entry 118(0)-118(E) in the compressed system memory 116 corresponding to the VA to store the compressed data 120. Further, the memory request buffer 142 may have to be sized to potentially buffer a large number of subsequent memory write requests to avoid the processor 110 stalling.

With continuing reference to FIG. 2, after the metadata 136 comes back from the metadata circuit 134 to update the metadata cache 128 (task 216), the metadata cache 128 provides the metadata 136 as metadata 132 to the compress circuit 124 (task 218). The compress circuit 124 determines if the new compression size of the compressed data 120 fits into the same memory block size in the compressed system memory 116 as used to previously store data for the VA of the evicted cache entry 106(0)-106(N). For example, the processor 110 may have updated the cache data 104(0)-104(N) in the evicted cache entry 106(0)-106(N) since being last stored in the compressed system memory 116. If a new memory block 125 is needed to store the compressed data 120 for the evicted cache entry 106(0)-106(N), the compress circuit 124 recycles an index 144 (shown in FIG. 1) to the current memory block 125 in the compression memory system 102 associated with the VA of the evicted cache entry 106(0)-106(N) to a free list 146 for reuse (task 220). The free list 146 contains lists 148(0)-148(L) of indexes 144 to available memory blocks 125 in the compressed system memory 116. The compress circuit 124 then obtains an index 144 from the free list 146 to a new, available memory block 125 of the desired memory block size in the compressed system memory 116 to store the compressed data 120 for the evicted cache entry 106(0)-106(N) (task 222). The compress circuit 124 then stores the compressed data 120 for the evicted cache entry 106(0)-106(N) in the memory block 125 in the compressed system memory 116 associated with the VA for the evicted cache entry 106(0)-106(N) determined from the metadata 132. For example, the metadata 132 may be used to determine a physical address (PA) and offset to address a memory entry 118(0)-118(E) and memory block 125 therein in the compressed system memory 116. Alternatively, the metadata 132 may be a PA and offset itself. The compress circuit 124 stores the compressed data 120 for the evicted cache entry 106(0)-106(N) in the memory block 125 in the compressed system memory 116 associated with the VA for the evicted cache entry 106(0)-106(N), whether the memory block 125 is the previously assigned memory block 125 or a newly assigned memory block 125 (task 224).

With continuing reference to FIG. 2, if a new memory block 125 was assigned to the VA for the evicted cache entry 106(0)-106(N), the metadata 132(0)-132(C) in the metadata cache entry 130(0)-130(C) corresponding to the VA 126(0)-126(N) of the evicted cache entry 106(0)-106(N) is updated based on the index 144 to the new memory block 125 (task 226). The metadata cache 128 then updates the metadata 136(0)-136(V) in the metadata entry 138(0)-138(V) corresponding to the VA in the metadata cache 128 is based on the index 144 to the new memory block 125 (task 228).

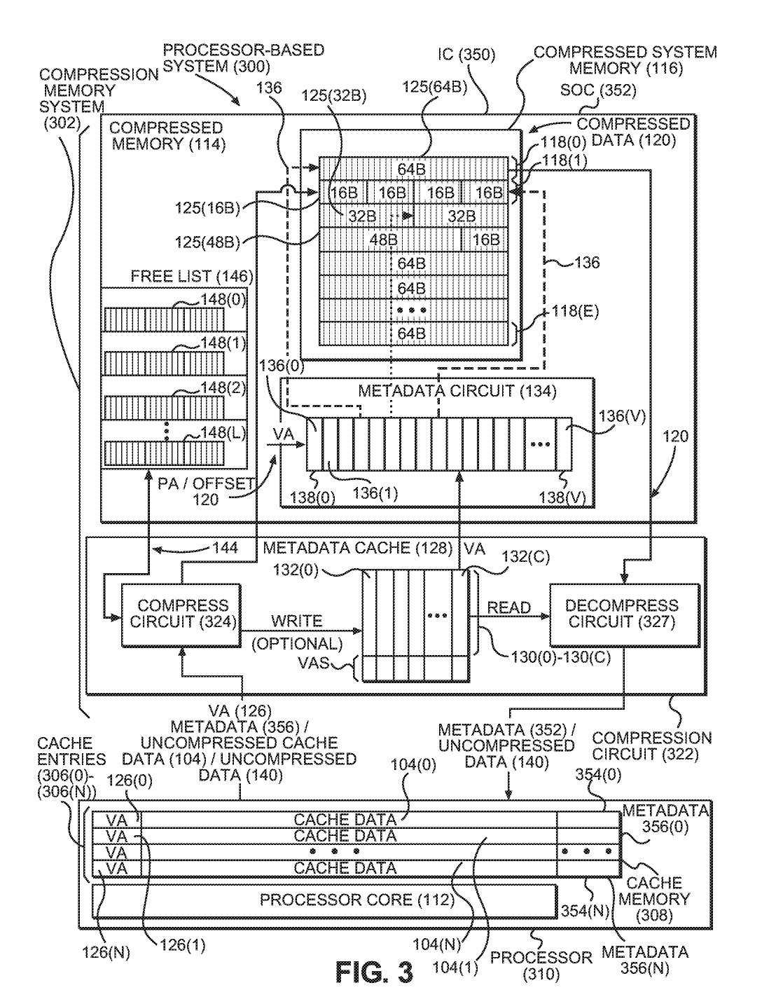

It may be desired to avoid the need to provide the memory request buffer 142 to store memory write requests, including cache data 104(0)-104(N) evictions in the compression circuit 122. In this regard, FIG. 3 illustrates an exemplary processor-based system 300 that is configured to avoid the need to buffer subsequent write operations from a processor during a cache eviction process. In this example, the processor-based system 300 includes a compression memory system 302 that includes the compressed system memory 116 in the processor-based system 100 in FIG. 1. The processor-based system 300 may be provided in a single integrated circuit (IC) 350 as a system-on-a-chip (SoC) 352. The processor-based system 300 also includes other common components with the processor-based system 100 in FIG. 1, which are shown with common element numbers between FIG. 1 and FIG. 3.

A processor 310 in the processor-based system 300 in FIG. 3 includes a cache memory 308 that may be private cache memory private to the processor core 112 in the processor 310 or shared cache memory shared between multiple processor cores, including the processor core 112 in the processor 310. As described in more detail below, the cache memory 308 has cache entries 306(0)-306(N) additionally including metadata entries 354(0)-354(N) each configured to directly store associated metadata 356(0)-356(N) therein. The metadata 356(0)-356(N) stored in the metadata entries 354(0)-354(N) is used to access a physical address (PA) in the compressed system memory 116 to access the memory entry 118(0)-118(E) and memory block 125 therein corresponding to the VA of the respective cache entry 306(0)-306(N). In response to an eviction of a cache entry 306(0)-306(N) from the cache memory 308, the cache memory 308 is configured to provide the metadata 356(0)-356(N) and the uncompressed cache data 104(0)-104(N) for the evicted cache entry 306(0)-306(N) to the compression circuit 322. The compression circuit 322 can then use the metadata 356(0)-356(N) from the evicted cache entry 306(0)-306(N) to store a compressed version of the cache data 104(0)-104(N) from the evicted cache entry 306(0)-306(N) in the memory entry 118(0)-118(E) at the physical address (PA) corresponding to the metadata 356(0)-356(N). Thus, the need to perform a lookup in a metadata cache, such as metadata cache 128, is avoided. Thus, stalls associated with cache misses to a metadata cache are avoided, which may avoid the need to buffer subsequent write operations from the processor 310. This may also avoid the need to stall the processor 310.

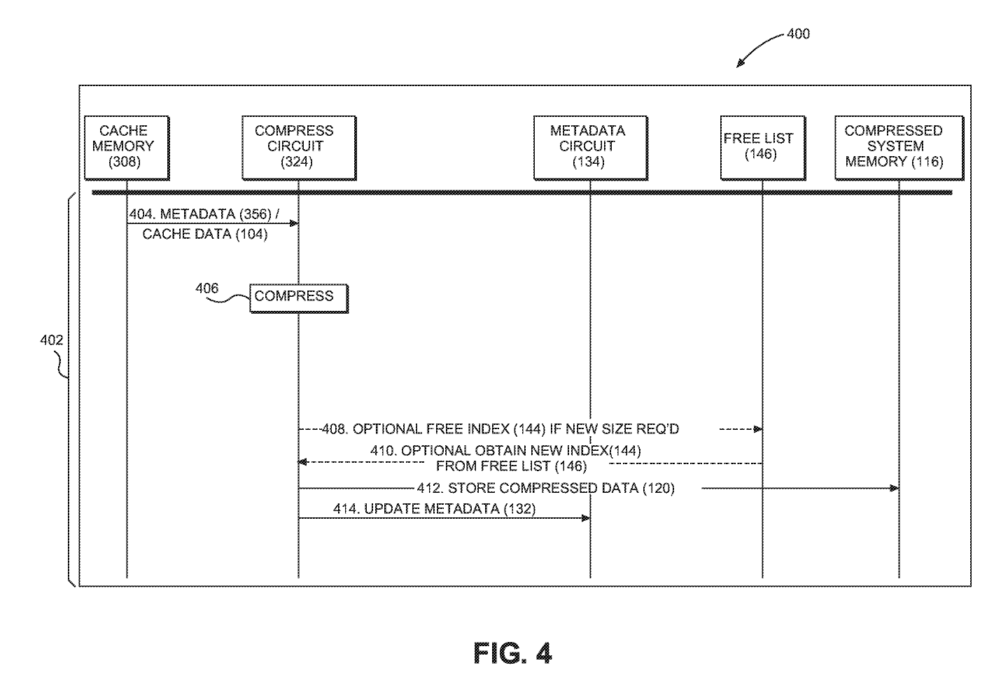

FIG. 4 is a flow diagram 400 illustrating an exemplary cache eviction process 402 performed in the processor-based system 300 in FIG. 3 when evicting a cache entry 306(0)-306(N) from the cache memory 308. With reference to FIG. 4, the cache memory 308 first sends the metadata 356 and the uncompressed cache data 104 of the evicted cache entry 306(0)-306(N) to a compress circuit 324 in the compression circuit 322 as part of the cache eviction process 402 (task 404). The compress circuit 324 receives the uncompressed cache data 104 and the associated metadata 356 for the evicted cache entry 306(0)-306(N) from the cache memory 308. The compress circuit 324 then compresses the uncompressed cache data 104 into compressed data 120 of a compression size to be stored in the compressed system memory 116 (task 406). For example, as shown in FIG. 3, the compress circuit 324 may be configured to compress sixty-four (64) byte (64 B) data words down to forty-eight (48) byte (48 B), thirty-two (32) byte (32 B), or sixteen (16) byte (16 B) compressed data words which can be stored in respective memory blocks 125(48 B), 125(32 B), 125(16 B) of less width than the entire width of a memory entry 118(0)-118(E). If uncompressed cache data 104 from the cache memory 308 cannot be compressed down to the next lower sized memory block 125 configured for the compression memory system 302, such uncompressed cache data 104 is stored uncompressed over the entire width of a memory entry 118(0)-118(E). For example, the width of the memory entry 118(0)-118(E) may be 64 B in this example that can store 64 B memory blocks 125(64 B).

With continuing reference to FIG. 4, the compress circuit 324 determines if the new compression size of the compressed data 120 fits into the same memory block size in the compressed system memory 116 as used to previously store data for the VA of the evicted cache entry 306(0)-306(N). For example, the processor 310 may have updated the cache data 104(0)-104(N) in the evicted cache entry 306(0)-306(N) since being last stored in the compressed system memory 116. If a new memory block 125 is needed to store the compressed data 120 for the evicted cache entry 306(0)-306(N), the compress circuit 324 recycles or frees an index 144 to the current memory block 125 in the compressed system memory 116 associated with the evicted cache entry 306(0)-306(N) to the free list 146 for reuse (task 408). The compress circuit 324 then obtains an index 144 from the free list 146 to a new, available memory block 125 of the desired memory block size in the compressed system memory 116 to store the compressed data 120 for the evicted cache entry 306(0)-306(N) (task 410). The compress circuit 324 then stores the compressed data 120 for the evicted cache entry 306(0)-306(N) in the memory block 125 in the compressed system memory 116 associated with the metadata 356 for the evicted cache entry 306(0)-306(N) (task 412). For example, the metadata 356 may be used to determine a physical address (PA) and offset to address a memory entry 118(0)-118(E) and memory block 125 therein in the compressed system memory 116. Alternatively, the metadata 356 may be a PA and offset itself. The compress circuit 324 stores the compressed data 120 for the evicted cache entry 306(0)-306(N) in the memory block 125 in the compressed system memory 116 associated with the metadata 356 for the evicted cache entry 306(0)-306(N) whether the memory block 125 is the previously assigned memory block 125 or a newly assigned memory block 125 (task 414).

With continuing reference to FIG. 4, if a new memory block 125 was assigned to the metadata 356 for the evicted cache entry 306(0)-306(N), the metadata 136(0)-136(V) in the metadata entry 138(0)-138(V) corresponding to the VA 126(0)-126(N) of the evicted cache entry 306(0)-306(N) is updated based on the index 144 to the new memory block 125 (task 414).

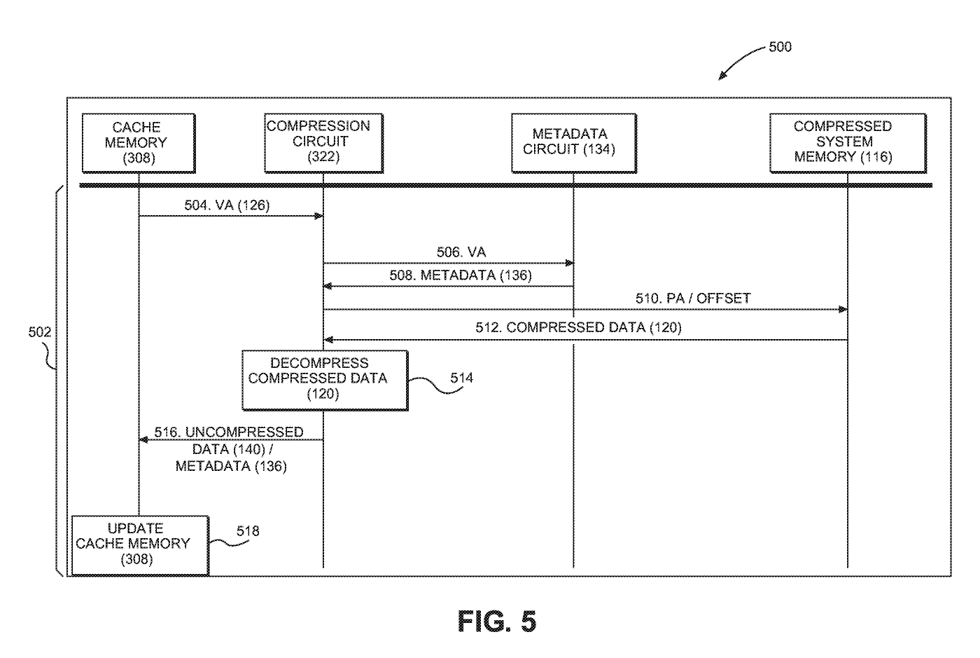

FIG. 5 is a flow diagram 500 illustrating an exemplary memory read operation process 502 that is performed in the processor-based system 300 in FIG. 3 in response to a cache miss to the cache memory 308 and the eviction of a cache entry 306(0)-306(N) from the cache memory 308 to the compressed system memory 116. In this regard, the cache memory 308 is configured to issue a memory read request for a memory read operation to the compression circuit 322 (task 504). The memory read request comprises the VA in the compressed system memory 116 to be read by the processor 310. In response, compression circuit 322 issues a metadata lookup request with the VA to the metadata circuit 134 in the compressed system memory 116 to receive the metadata 136 associated with the memory read request (task 506). The compression circuit 322 then receives the metadata 136 associated with the VA for the memory read request from the metadata circuit 134 (task 508). The compression circuit 322 uses the metadata 136 received from the metadata circuit 134 to determine the physical address (PA) of the memory entry 118(0)-118(E) and the offset to the memory block 125 therein in the compressed system memory 116 associated with the VA of the memory read request (task 510). The compression circuit 322 then accesses the memory block 125 of memory entry 118(0)-118(E) corresponding to the VA of the memory read request to obtain the compressed data 120 for the memory read request (task 512).

With continuing reference to FIG. 5, the decompress circuit 327 in the compression circuit 322 then decompresses the compressed data 120 into uncompressed data 140 (task 514). The decompress circuit 327 provides the uncompressed data 140 to the cache memory 308 to be inserted in an available cache entry 306(0)-306(N) (task 516). The cache memory 308 inserts the uncompressed data 140 in the available cache entry 306(0)-306(N) corresponding to the VA of the memory read request (task 518). The decompress circuit 327 also provides the metadata 136 received from the metadata circuit 134 to provide in the available cache entry 306(0)-306(N) as corresponding metadata 356(0)-356(N). In this manner, if this cache entry 306(0)-306(N) is later evicted, the metadata 356(0)-356(N) is available to be used to evict the cache entry 306(0)-306(N) into the compressed system memory 116 as discussed above with regard to the cache eviction process 402 in FIG. 4.

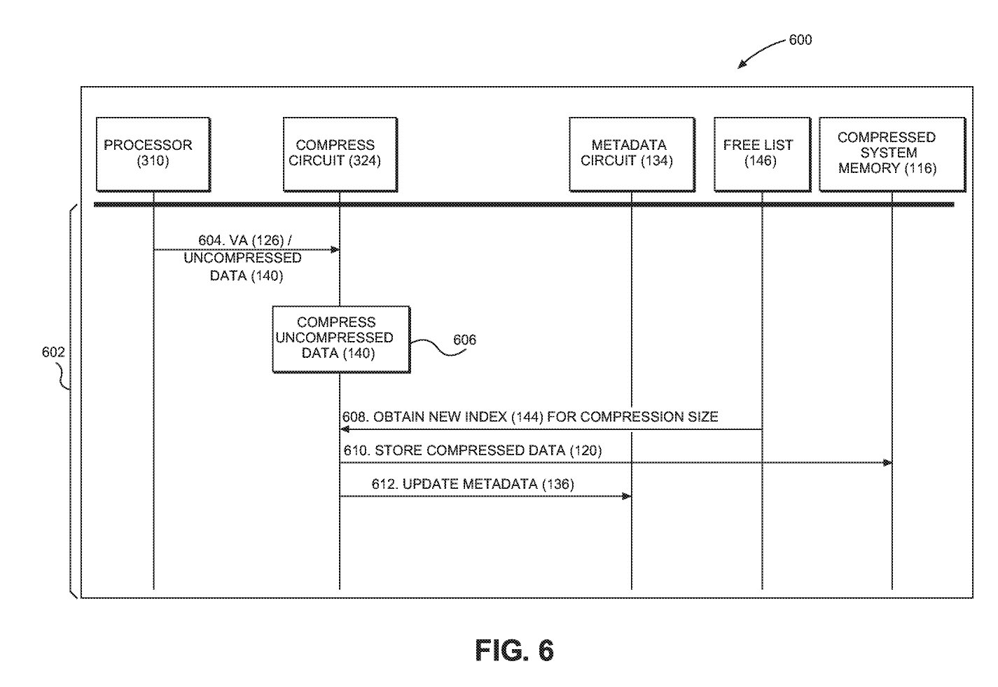

FIG. 6 is a flow diagram 600 illustrating an exemplary memory write process 602 in the processor-based system 300 in FIG. 3 that is not a cache eviction. In this regard, the processor 310 is configured to issue a memory write request for a memory write operation to the compression circuit 324 (task 604). The memory write request comprises write data, that is uncompressed data 140 to be written and the VA of the location in the compressed system memory 116 to be written. In response, the compress circuit 324 compresses the received uncompressed data 140 into compressed write data as compressed data 120 of a compression size (task 606). The compress circuit 324 obtains an index 144 for an available memory block 125 in the compressed system memory 116 from the free list 146 based on the compression size of the compressed data 120 (task 608). The compress circuit 324 uses the index 144 received from the free list 146 to determine the physical address (PA) of the memory entry 118(0)-118(E) and the offset to the memory block 125 therein in the compressed system memory 116 to write the compressed data 120 (task 610). The compress circuit 324 then writes metadata 136 to the metadata entry 138(0)-138(V) in the metadata circuit 134 in the compressed system memory 116 corresponding to the VA of the memory write request to be accessed during a subsequent memory read operation to the VA, as described above in FIG. 5 (task 612). If the processor-based system 300 includes the metadata cache 128, the compress circuit 324 can also be configured to update the metadata 132 for metadata cache entry 130(0)-130(C) corresponding to the VA or create a new metadata cache entry 130(0)-130(C).

A processor-based system that includes a cache memory that includes metadata for its cache entries in an uncompressed cache memory for mapping evicted cache entries to physical addresses in a compressed system memory as part of a compression memory system may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

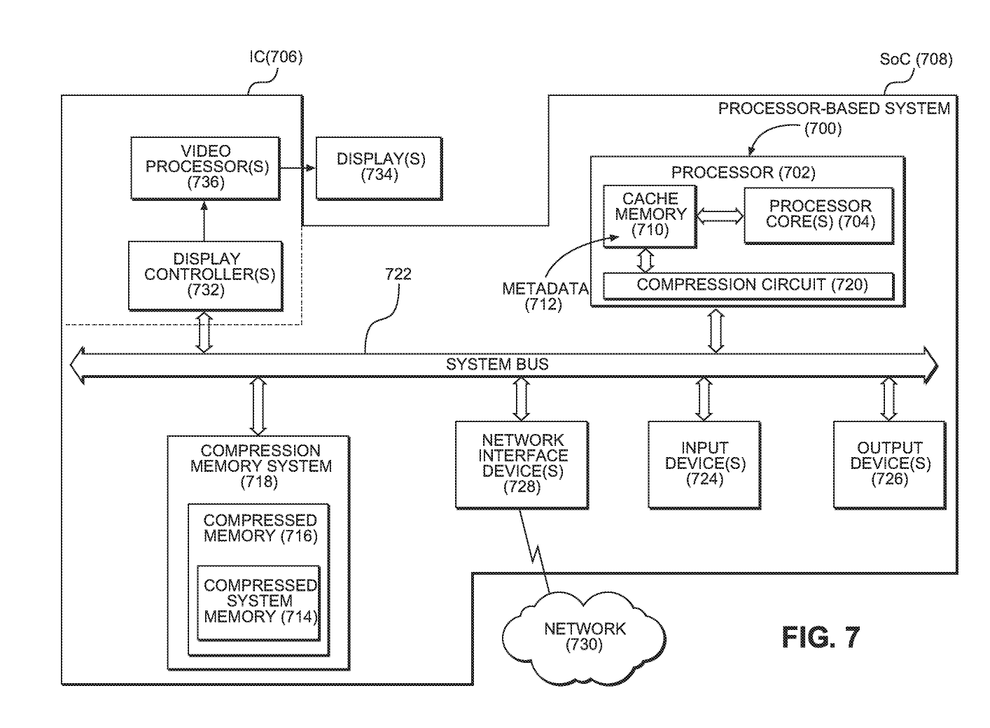

In this regard, FIG. 7 illustrates an example of a processor-based system 700 that includes a processor 702 that includes one or more processor cores 704. The processor-based system 700 is provided in an IC 706. The IC 706 may be included in or provided as a SoC 708 as an example. The processor 702 includes a cache memory 710 that includes metadata 712 for its uncompressed cache entries for mapping evicted cache entries to physical addresses in a compressed system memory 714 as part of a compressed memory 716 in a compression memory system 718. For example, the processor 702 may be the processor 310 in FIG. 3, the cache memory 710 may be the cache memory 308 in FIG. 3, and the compression memory system 302 in FIG. 3 may be the compression memory system 718, as non-limiting examples. In this regard, the compressed system memory 714 may be the compressed system memory 116 in FIG. 3. A compression circuit 720 is provided for compressing and decompressing data to and from the compressed system memory 714. The compression circuit 720 may be provided in the processor 702 or outside of the processor 702 and communicatively coupled to the processor 702 through a shared or private bus. The compression circuit 720 may be the compression circuit 322 in FIG. 3 as a non-limiting example.

The processor 702 is coupled to a system bus 722 to intercouple master and slave devices included in the processor-based system 700. The processor 702 can also communicate with other devices by exchanging address, control, and data information over the system bus 722. Although not illustrated in FIG. 7, multiple system buses 722 could be provided, wherein each system bus 722 constitutes a different fabric. For example, the processor 702 can communicate bus transaction requests to the compression memory system 718 as an example of a slave device. Other master and slave devices can be connected to the system bus 722. As illustrated in FIG. 7, these devices can include one or more input devices 724. The input device(s) 724 can include any type of input device, including but not limited to input keys, switches, voice processors, etc. The input device(s) 724 may be included in the IC 706 or external to the IC 706, or a combination of both. Other devices that can be connected to the system bus 722 can also include one or more output devices 726 and one or more network interface devices 728. The output device(s) 726 can include any type of output device, including but not limited to audio, video, other visual indicators, etc. The output device(s) 726 may be included in the IC 706 or external to the IC 706, or a combination of both. The network interface device(s) 728 can be any devices configured to allow exchange of data to and from a network 730. The network 730 can be any type of network, including but not limited to a wired or wireless network, a private or public network, a local area network (LAN), a wireless local area network (WLAN), a wide area network (WAN), a BLUETOOTH™ network, and the Internet. The network interface device(s) 728 can be configured to support any type of communications protocol desired.

Other devices that can be connected to the system bus 722 can also include one or more display controllers 732 as examples. The processor 702 may be configured to access the display controller(s) 732 over the system bus 722 to control information sent to one or more displays 734. The display controller(s) 732 can send information to the display(s) 734 to be displayed via one or more video processors 736, which process the information to be displayed into a format suitable for the display(s) 734. The display controller(s) 732 and/or the video processor(s) 736 may be included in the IC 706 or external to the IC 706, or a combination of both.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master devices and slave devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A memory system, comprising:
a compression circuit configured to store compressed data in a memory block in a memory entry among a plurality of memory entries in a compressed system memory, each memory entry among the plurality of memory entries addressable by a physical address; and
a cache memory communicatively coupled to the compression circuit, the cache memory comprising a plurality of cache entries each configured to store uncompressed cache data and an associated metadata associated with a physical address identifying a memory entry in the compressed system memory containing compressed cache data;
in response to an eviction of a cache entry from the cache memory:
the cache memory configured to provide uncompressed cache data and the associated metadata from the cache entry to be evicted among the plurality of cache entries to the compression circuit; and
the compression circuit configured to:
receive the uncompressed cache data and the associated metadata from the cache entry to be evicted among the plurality of cache entries in the cache memory;
compress the uncompressed cache data into compressed data of a compression size; and
store the compressed data in a memory block in a memory entry at a physical address in the compressed system memory associated with the received associated metadata with the evicted cache entry.

2. The memory system of claim 1, wherein the compression circuit is configured to store the compressed data in the memory block at the physical address in the compressed system memory indicated by the received associated metadata with the evicted cache entry.

3. The memory system of claim 1, wherein the compression circuit is further configured to:
determine if the memory block at the physical address in the compressed system memory associated with the associated metadata with the evicted cache entry can accommodate the compression size of the compressed data;
in response to determining that the memory block cannot accommodate the compression size of the compressed data:
obtain an index to a new memory block associated with a memory entry at a new physical address from a free list; and
store the compressed data in the new memory block in the memory entry at the new physical address in the compressed system memory based on the obtained index; and
free the index associated with the associated metadata with the evicted cache entry in the free list.

4. The memory system of claim 1, wherein in response to a cache miss for a memory read operation:
the compression circuit is further configured to:
receive a memory read request comprising a virtual address for the memory read operation;
provide the virtual address of the memory read request to the compressed system memory;
receive compressed data from a memory entry at a physical address in the compressed system memory mapped to the virtual address;
receive metadata associated with the physical address in the compressed system memory mapped to the virtual address from the compressed system memory; and
decompress the received compressed data into uncompressed data; and
the cache memory is further configured to:
store the uncompressed data in an available cache entry in the cache memory; and
store the metadata associated with the physical address in the compressed system memory mapped to the virtual address in the available cache entry.

5. The memory system of claim 1, wherein in response to a memory write operation, the compression circuit is further configured to:
receive a memory write request comprising a virtual address and write data for the memory write operation;
compress the write data to compressed write data of a compression size;
determine a physical address of a memory entry in the compressed system memory that has an available memory block for the compression size of the compressed write data; and
write the compressed write data to the available memory block in the memory entry of the determined physical address.

6. The memory system of claim 5, further comprising a metadata cache comprising a plurality of metadata cache entries each indexed by a virtual address, each metadata cache entry among the plurality of metadata cache entries comprising metadata associated with a physical address in the compressed system memory;
wherein in response to the memory write operation, the compression circuit is further configured to store metadata in a metadata cache entry in a metadata cache associated with the virtual address for the memory write request, the metadata associated with the determined physical address for the memory write operation.

7. The memory system of claim 1, wherein the cache memory is a private cache memory to a processor core.

8. The memory system of claim 1, wherein the cache memory is a shared cache memory to a plurality of processor cores.

9. The memory system of claim 1 integrated into a processor-based system.

10. The memory system of claim 1 integrated into a system-on-a-chip (SoC) comprising a processor.

11. The memory system of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device (e.g., a smart watch, a health or fitness tracker, eyewear, etc.); a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

12. A method of evicting cache data from an evicted cache entry to a compressed system memory, comprising:
receiving uncompressed cache data and associated metadata from a cache entry to be evicted among a plurality of cache entries in a cache memory;
compressing the uncompressed cache data into compressed data of a compression size; and
storing the compressed data in a memory block in a memory entry at a physical address in a compressed system memory, the physical address associated with the received associated metadata with the evicted cache entry.

13. The method of claim 12, comprising storing the compressed data in a memory block in a memory entry at the physical address in the compressed system memory indicated by the received associated metadata with the evicted cache entry.

14. The method of claim 12, further comprising:
determining if the memory block at the physical address in the compressed system memory associated with the associated metadata with the evicted cache entry can accommodate the compression size of the compressed data;
in response to determining that the memory block cannot accommodate the compression size of the compressed data:
obtaining an index to a new memory block in a memory entry associated with a new physical address from a free list; and
storing the compressed data in the new memory block in the memory entry at the new physical address in the compressed system memory based on the obtained index; and
freeing the index associated with the associated metadata with the evicted cache entry in the free list.

15. The method of claim 12, wherein in response to a cache miss for a memory read operation, further comprising:
receiving compressed data from a memory entry at a physical address in the compressed system memory mapped to the virtual address in response to a memory read request comprising a virtual address for the memory read operation;
receiving metadata associated with the physical address in the compressed system memory mapped to the virtual address from the compressed system memory;
decompressing the received compressed data into uncompressed data;
storing the uncompressed data in an available cache entry in the cache memory; and
storing the metadata associated with the physical address in the compressed system memory mapped to the virtual address in the available cache entry.

16. The method of 12, wherein in response to a memory write operation, further comprising:
receiving a memory write request comprising a virtual address and write data for a memory write operation;
compressing the write data to compressed write data of a compression size;
determining a physical address of a memory entry in the compressed system memory that has an available memory block for the compression size of the compressed write data; and
writing the compressed write data to the available memory block in the memory entry of the determined physical address.

17. The method of claim 16, wherein in response to the memory write operation, further comprising storing metadata in a metadata cache entry among a plurality of metadata cache entries in a metadata cache, the metadata cache entry associated with the virtual address for the memory write request, and the metadata associated with the determined physical address for the memory write operation.

18. A processor-based system, comprising:
a processor core configured to issue memory read operations and memory write operations;
a compressed system memory comprising a plurality of memory entries each addressable by a physical address and each configured to store compressed data;
a cache memory communicatively coupled to the processor core, the cache memory comprising a plurality of cache entries each configured to store uncompressed cache data and an associated metadata associated with a physical address identifying a memory entry in the compressed system memory containing compressed cache data; and
a compression circuit configured to store compressed data in a memory block in a memory entry among the plurality of memory entries in the compressed system memory; and
in response to an eviction of a cache entry from the cache memory:
the cache memory configured to provide the uncompressed cache data and the associated metadata from the cache entry to be evicted among the plurality of cache entries to the compression circuit; and
the compression circuit configured to:
receive the uncompressed cache data and the associated metadata from the cache entry to be evicted among the plurality of cache entries in the cache memory;
compress the uncompressed cache data into compressed data of a compression size; and
store the compressed data in a memory block in a memory entry at a physical address in the compressed system memory associated with the received associated metadata with the evicted cache entry.

19. The processor-based system of claim 18, wherein in response to a cache miss for a memory read operation:
the compression circuit is further configured to:
receive a memory read request comprising a virtual address for the memory read operation;
provide the virtual address of the memory read request to the compressed system memory;
receive compressed data from a memory entry at a physical address in the compressed system memory mapped to the virtual address;
receive metadata associated with the physical address in the compressed system memory mapped to the virtual address from the compressed system memory; and
decompress the received compressed data into uncompressed data; and
the cache memory is further configured to:
store the uncompressed data in an available cache entry in the cache memory; and
store the metadata associated with the physical address in the compressed system memory mapped to the virtual address in the available cache entry.

20. The processor-based system of claim 18, further comprising a metadata cache comprising a plurality of metadata cache entries each indexed by a virtual address, each metadata cache entry among the plurality of metadata cache entries comprising metadata associated with a physical address in the compressed system memory; and
in response to a memory write operation, the compression circuit is further configured to:
receive a memory write request comprising a virtual address and write data for the memory write operation;
compress the write data to compressed write data of a compression size;
determine a physical address of a memory entry in the compressed system memory that has an available memory block for the compression size of the compressed write data;
write the compressed write data to the available memory block in the memory entry of the determined physical address; and
store metadata in a metadata cache entry in a metadata cache associated with the virtual address for the memory write request, the metadata associated with the determined physical address for the memory write operation.
